(19) United States
(12) Patent Application Publication
(10) Pub. No.: US 2021/0143479 A1
(43) Pub. Date: May 13, 2021

(54) NON-AQUEOUS ELECTROLYTE SOLUTION AND LITHIUM METAL SECONDARY BATTERY AND LITHIUM ION SECONDARY BATTERY INCLUDING THE SAME

(71) Applicants: National Taiwan University of Science and Technology, Taipei (TW); Amita Technologies, Inc., Taoyuan City (TW)

(72) Inventors: Bing-Joe Hwang, Taipei (TW); Wei-Nien Su, Taipei (TW); Jing-Yih Cherng, Taoyuan City (TW)

(73) Assignees: National Taiwan University of Science and Technology, Taipei (TW); Amita Technologies, Inc., Taoyuan City (TW)

(21) Appl. No.: 17/033,691

(22) Filed: Sep. 26, 2020

(30) Foreign Application Priority Data
Nov. 11, 2019 (TW) 108140870

(51) Int. Cl. H01M 10/0569; H01M 10/052; H01M 10/0525

(52) U.S. Cl. CPC H01M 10/0569; H01M 10/052; H01M 2300/0037; H01M 2300/0034; H01M 10/0525

(57) ABSTRACT

A non-aqueous electrolyte solution is provided. An organic solvent in the non-aqueous electrolyte includes at least one fluorine-containing cyclic carbonate and at least one fluorine-containing ether. The at least one fluorine-containing cyclic carbonate and the at least one fluorine-containing ether have a volume ratio of 1:9˜9:1. A lithium metal secondary battery and a lithium ion secondary battery including the non-aqueous electrolyte solution are also provided.

### CROSS-REFERENCE TO RELATED APPLICATION

This application claims the priority benefit of Taiwan application serial no. 108140870, filed on Nov. 11, 2019. The entirety of the above-mentioned patent application is hereby incorporated by reference herein and made a part of this specification.

### BACKGROUND

### Field of the Disclosure

The disclosure relates to a non-aqueous electrolyte solution and a lithium metal secondary battery or lithium ion secondary battery including the non-aqueous electrolyte solution.

### Description of Related Art

With the growing demand for energy, the development of energy storage devices such as lithium batteries with higher energy density has become one of the current trends. The conventional lithium ion secondary battery uses graphite as its negative electrode, however, graphite cannot provide the desired energy due to its low energy density. To address this problem, the solution to make the battery with higher energy density may include increasing the voltage of the battery and using a metal with a high specific capacity as the negative electrode of the battery, etc. Accordingly, high-voltage lithium-metal batteries (HVLMBs) are regarded as one of the energy storage devices with excellent potential because the lithium metal negative electrode of such battery has high specific capacity (about 3860 mAh/g) and low oxidation reduction potential. However, high-voltage lithium metal batteries often have low coulombic efficiency, power retention rate, and cycle life during charging and discharging due to the high activity of lithium metal, the decomposition of electrolyte solution at the positive electrode, and the unstable interface film formed at the negative electrode. In addition, anode-free lithium-metal batteries (AFLMBs) designed with no anode are also considered as one of the energy storage devices with excellent potential, which are characterized in that the negative electrode thereof does not include any active materials, and work in the manner of reversibly and repeatedly electroplating and stripping on negative electrode through the lithium ion from the positive electrode. However, such working method will form a more unstable interface film on the negative electrode and also causes the problem that electrolyte solution is easily decomposed on the positive electrode surface.

In order to solve the above problems caused by lithium metal secondary batteries or lithium ion secondary battery, the disclosure provides a novel non-aqueous electrolyte solution for lithium metal secondary battery or lithium ion secondary battery. The conventional lithium metal secondary battery often use cyclic carbonates such as ethylene carbonate or propylene carbonate as the organic solvent in the non-aqueous electrolyte solution. However, the cyclic carbonate has a high melting point and have extremely high reactivity to negative electrode using metal as the material and high-voltage positive electrode, which will cause the lithium metal secondary battery to form an unstable interface film on the negative electrode during charging and discharging. Unstable interface films include, for example, dendrites and dead lithium, which will cause the lithium metal secondary battery to have lower coulombic efficiency as well as power retention rate and reduce the cycle life of the lithium metal secondary battery. Moreover, the conventional lithium ion secondary battery also has the above problems, and cannot effectively suppress the growth of dendrites and the decomposition reaction of the electrolyte solution caused by high voltage in the positive electrode during overcharging.

### SUMMARY OF THE DISCLOSURE

The disclosure provides a non-aqueous electrolyte solution and a lithium metal secondary battery or a lithium ion secondary battery including the same. The above-mentioned lithium metal secondary battery or lithium ion secondary battery has higher coulombic efficiency, power retention rate and cycle life by including the non-aqueous electrolyte solution of the disclosure.

The non-aqueous electrolyte solution for lithium metal secondary battery or lithium ion secondary battery of the disclosure includes at least one fluorine-containing cyclic carbonate and at least one fluorine-containing ether. The volume ratio of the at least one fluorine-containing cyclic carbonate to the at least one fluorine-containing ether is 1:9 to 9:1.

In an embodiment of the disclosure, the at least one fluorine-containing cyclic carbonate includes 4-fluoro-1,3-dioxolan-2-one (FEC), 4,5-difluoro-1,3-dioxolan-2-one (DFEC), 3,3,3-fluoroethylmethyl carbonate (FEMC), ethyl difluoroacetate (DFEAc), di-2,2,2-trifluoroethyl carbonate (TFEC) or a combination thereof.

In an embodiment of the disclosure, the at least one fluorine-containing ether includes 1,1,2,2-Tetrafluoroethyl-2,2,3,3-tetrafluoropropyl ether (TTE), propyl 1,1,2,2-tetrafluoroethyl ether, 1,1,2,2-tetrafluoroethyl-2,2,2-trifluoroethyl ether (HFE), 1,1,1,2,2,3,3,4,4-nonafluoro-4-methoxybutane (PFE-1), 2-[difluoro (methoxy) methyl]-1,1,1,2,3,3,3-heptafluoropropane (PFE-2) or a combination thereof.

In an embodiment of the disclosure, the volume ratio of the at least one fluorine-containing cyclic carbonate to the at least one fluorine-containing ether is 2:8 to 1:1.

In an embodiment of the disclosure, the volume ratio of the at least one fluorine-containing cyclic carbonate to the at least one fluorine-containing ether is 3:7.

In an embodiment of the disclosure, the non-aqueous electrolyte solution includes one fluorine-containing cyclic carbonate and one fluorine-containing ether.

In an embodiment of the disclosure, the non-aqueous electrolyte solution further includes lithium salt.

In another embodiment of the disclosure, the non-aqueous electrolyte solution for lithium metal secondary battery of the disclosure includes at least one fluorine-containing cyclic carbonate, at least one fluorine-containing ether and at least one non-fluorinated carbonate. The volume ratio of the at least one fluorine-containing cyclic carbonate to the at least one fluorine-containing ether to the at least one non-fluorinated carbonate is 3:(6˜3):(1˜4).

In an embodiment of the disclosure, the at least one non-fluorinated carbonate comprises ethyl methyl carbonate (EMC), diethyl carbonate (DEC), dimethyl carbonate (DMC) or a combination thereof.

In an embodiment of the disclosure, the volume ratio of the at least one fluorine-containing cyclic carbonate to the at least one fluorine-containing ether to the at least one non-fluorinated carbonate is 3:5:2.

The lithium metal secondary battery or lithium ion secondary battery of the disclosure includes a negative electrode, a positive electrode, and the above-mentioned non-aqueous electrolyte solution.

Based on the above, the disclosure provides a non-aqueous electrolyte solution that can be used for a high-voltage lithium metal secondary battery and a lithium-ion secondary battery including high-voltage positive electrode materials, and the content thereof includes fluorine-containing cyclic carbonate and fluorine-containing ether, and the volume ratio thereof is 1:9 to 9:1. Furthermore, in preferred embodiment of the disclosure, the content of the non-aqueous electrolyte solution further includes non-fluorinated carbonate, and the volume ratio of the fluorine-containing cyclic carbonate to the fluorine-containing ether to the non-fluorinated carbonate is 3:(6˜3):(1˜4). Based on the above, the non-aqueous electrolyte solution of the disclosure allows the negative electrode of a lithium metal secondary battery or a lithium ion secondary battery to form a stable interface film during charging and discharging, and thus has high coulombic efficiency, power retention rate, and cycle life.

In order to make the above features and advantages of the disclosure more comprehensible, embodiments are described below in detail with the accompanying drawings as follows.

### BRIEF DESCRIPTION OF THE DRAWINGS

FIG. 1 is a schematic cross-sectional view of a lithium metal secondary battery or a lithium ion secondary battery according to an embodiment of the disclosure.

FIG. 2 is a curve diagram showing the coulombic efficiency and specific capacity, which are changed along with the number of cycles, of a lithium metal secondary battery according to an embodiment of the disclosure.

FIG. 3 shows a voltage-to-time curve diagram for electroplating/stripping performance of lithium in a lithium metal secondary battery according to an embodiment of the disclosure.

FIG. 4 shows a charge-discharge curve diagram of a lithium metal secondary battery according to an embodiment of the disclosure.

FIG. 5 shows an AC impedance diagram of a lithium metal secondary battery according to an embodiment of the disclosure.

FIG. 6 shows an AC impedance diagram of a lithium metal secondary battery of a comparative example.

FIG. 7 shows a discharge curve diagram of the lithium metal secondary battery including the non-aqueous electrolyte solution in Example 1 to Example 8 of the disclosure after undergoing 20 cycles.

FIG. 8 is a curve diagram showing the coulombic efficiency, which is changed along with the number of cycles, of the lithium metal secondary battery including non-aqueous electrolyte solution in Example 1 to Example 8 of the disclosure.

FIG. 9 is a curve diagram showing the power retention rate, which is changed along with the number of cycles, of the lithium metal secondary battery including non-aqueous electrolyte solution in Example 1 to Example 8 of the disclosure.

FIG. 10 shows a charge-discharge curve diagram of the anode-free lithium metal secondary battery including the non-aqueous electrolyte solution in Example 3 and Comparative Example 2 of the disclosure after undergoing 3 cycles and 15 cycles respectively.

FIG. 11 is a curve diagram showing the specific capacity, which is changed along with the number of cycles, of the anode-free lithium metal secondary battery including non-aqueous electrolyte solution in Example 3 and Comparative Example 2 of the disclosure, wherein the current density is 0.5 mA/cm², and the cycle runs at a voltage of 2.5 to 4.5V.

FIG. 12 is a curve diagram showing the coulombic efficiency, which is changed along with the number of cycles, of the anode-free lithium metal secondary battery including non-aqueous electrolyte solution in Example 3 and Comparative Example 2 of the disclosure, wherein the current density is 0.5 mA/cm², and the cycle runs at a voltage of 2.5 to 4.5V.

FIG. 13A shows a charge-discharge curve diagram of the lithium metal secondary battery in Example A including the non-aqueous electrolyte solution in Example 3 and Comparative Example 2 of the disclosure after undergoing 1 cycle and 100 cycles respectively.

FIG. 13B is a curve diagram showing the specific capacity, which is changed along with the number of cycles, of the lithium metal secondary battery in Example A including non-aqueous electrolyte solution in Example 3 and Comparative Example 2 of the disclosure, wherein the current density is 0.5 mA/cm², and the cycle runs at a voltage of 2.5 to 4.5V.

FIG. 14A shows a charge-discharge curve diagram of the lithium ion secondary battery in Example B including the non-aqueous electrolyte solution in Example 3 and Comparative Example 2 of the disclosure after undergoing 1 cycle and 150 cycles respectively.

FIG. 14B is a curve diagram showing the specific capacity, which is changed along with the number of cycles, of the lithium ion secondary battery in Example B including non-aqueous electrolyte solution in Example 3 and Comparative Example 2 of the disclosure, wherein the current density is 0.5 mA/cm², and the cycle runs at a voltage of 2.5 to 4.5V.

FIG. 15A shows a charge-discharge curve diagram of the lithium ion secondary battery in Example C including the non-aqueous electrolyte solution in Example 3 and Comparative Example 2 of the disclosure after undergoing 1 cycle and 150 cycles respectively.

FIG. 15B is a curve diagram showing the specific capacity, which is changed along with the number of cycles, of the lithium ion secondary battery in Example C including non-aqueous electrolyte solution in Example 3 and Comparative Example 2 of the disclosure, wherein the current density is 0.5 mA/cm², and the cycle runs at a voltage of 3.2 to 5 V.

FIG. 16 shows a charge-discharge curve diagram of the anode-free lithium metal secondary battery including the non-aqueous electrolyte solution in Example 18 of the disclosure after undergoing 1 cycle, 5 cycles, 10 cycles and 15 cycles respectively.

FIG. 17 shows a charge-discharge curve diagram of the anode-free lithium metal secondary battery including the non-aqueous electrolyte solution in Comparative Example 14 of the disclosure after undergoing 1 cycle, 5 cycles, 10 cycles and 15 cycles respectively.

FIG. 18 shows a charge-discharge curve diagram of the anode-free lithium metal secondary battery including the non-aqueous electrolyte solution in Comparative Example 15 of the disclosure after undergoing 1 cycle, 5 cycles, 10 cycles and 15 cycles respectively.

FIG. 19 is a curve diagram showing the specific capacity, which is changed along with the number of cycles, of the anode-free lithium metal secondary battery including non-aqueous electrolyte solution in Example 18, Comparative Example 14 and Comparative Example 15 of the disclosure, wherein the charge density is 0.2 mA/cm², discharge density is 0.5 mA/cm² and the cycle runs at a voltage of 2.5 to 4.5V.

FIG. 20 is a curve diagram showing the power retention rate and the coulombic efficiency, which are changed along with the number of cycles, of the anode-free lithium metal secondary battery including non-aqueous electrolyte solution in Example 18, Comparative Example 14 and Comparative Example 15 of the disclosure, wherein the charge density is 0.2 mA/cm², discharge density is 0.5 mA/cm² and the cycle runs at a voltage of 2.5 to 4.5V.

### DESCRIPTION OF EMBODIMENTS

In the drawings, the thickness of layers, films, regions, etc. are exaggerated for clarity. Throughout the specification, the same reference numerals indicate the same components. It should be understood that when a component such as a layer, film, or region is referred to as being “on” or “connected to” another component, it can be directly on or connected to the other component, or an intermediate component can also exist. Conversely, when a component is referred to as being “directly on another component” or “directly connected to” another component, there is no intermediate component.

FIG. 1 is a schematic cross-sectional view of a lithium metal secondary battery or a lithium ion secondary battery according to an embodiment of the disclosure.

In an embodiment, the lithium metal secondary battery or lithium ion secondary battery 10 may include a negative electrode 100, a positive electrode 110, a separator film 120, and a non-aqueous electrolyte solution.

In an embodiment, the negative electrode 100 may include a negative electrode current collector 102 and a negative electrode active material 104. Based on the requirement for conductivity that can communicate with external terminals, the material of the negative electrode current collector 102 may include, for example, copper, nickel, gold-plated copper, silver-plated copper, thorium, etc. The form of the negative electrode current collector 102 may include, for example, a metallic foil, a foam or a substrate with or without nanostructure. In addition, in consideration of the need to release lithium ions when the lithium metal secondary battery or the lithium ion secondary battery 10 is discharged and the need to receive lithium ions during charging to avoid rapid changes in the volume of the interface film, the negative electrode active material 104 may include carbon, carbide, silicide, silver, tin or lithium and other metals.

In another embodiment, the negative electrode 100 may not include the negative electrode active material 104 but only include the negative electrode current collector 102, that is, an anode-free lithium metal secondary battery. For the anode-free lithium metal secondary battery, an ultra-thin lithium metal thin film can be formed on the negative electrode current collector 102 during charging, and the lithium metal thin film will be stripped off from the negative electrode current collector 102 during discharging, dissolved in the non-aqueous electrolyte solution and embedded into the positive electrode 110.

In an embodiment, the positive electrode 110 may include a positive electrode current collector 112 and a positive electrode active material 114. Based on the requirement for conductivity that can communicate with external terminals, the material of the positive electrode current collector 112 can be, for example, aluminum, nickel, titanium, etc. and the material of the positive electrode current collector 112 can be, for example, the same as or different from the material of the negative electrode current collector 102. In addition, as a source of supplying lithium ions, the positive electrode active material 114 includes lithium metal oxides, phosphoric acid compounds, etc., and in order to make the lithium metal secondary battery or the lithium ion secondary battery 10 have a high energy density, the positive electrode active material 114 may include a high-voltage positive electrode material. Specifically, the positive electrode active material 114 may include LiCoO₂, LiNiₓMn_{y}Co_{z}O₂, LiNiₓAl_{y}Co_{z}O₂, LiFePO₄, etc.

The separator film 120 can be used to inhibit the conduction of electrons between the negative electrode 100 and the positive electrode 110 without hindering the penetration of lithium ions, and is not eroded by the non-aqueous electrolyte solution. In an embodiment, the separator film 120 includes an insulating material. For example, the separator film 120 may be polypropylene, polyethylene, polyethylene terephthalate, polyimide, or polyvinylidene fluoride.

In addition, an embodiment of the disclosure provides a non-aqueous electrolyte solution for lithium metal secondary battery and lithium ion secondary battery.

The non-aqueous electrolyte solution can be dissolved in the lithium metal secondary battery or the lithium ion secondary battery 10, and can absorb the lithium ions that are respectively consumed and released from the negative electrode 100 or the positive electrode 110 during charging and discharging. On this occasion, the non-aqueous electrolyte solution needs to have a low viscosity and the ability to impregnate the negative electrode 100 and the positive electrode 110, and includes, for example, an organic solvent and electrolyte.

In an embodiment, the organic solvent in the non-aqueous electrolyte solution includes at least one fluorine-containing cyclic carbonate and at least one fluorine-containing ether. For example, the organic solvent in the non-aqueous electrolyte solution may include one fluorine-containing cyclic carbonate and one fluorine-containing ether, or may include two fluorine-containing cyclic carbonates and one fluorine-containing ether. It should be noted here that fluorine-containing cyclic carbonate refers to fluorine-substituted cyclic carbonate, and fluorine-containing ether refers to fluorine-substituted ether.

In an embodiment, the fluorine-containing cyclic carbonate can be selected from a group consisting of 4-fluoro-1,3-dioxolan-2-one (FEC), 4,5-difluoro-1,3-dioxolan-2-one (DFEC), 3,3,3-fluoroethylmethyl carbonate (FEMC), ethyl difluoroacetate (DFEAc) and di-2,2,2-trifluoroethyl carbonate (TFEC). The fluorine-containing cyclic carbonate can be used to improve the interface chemical property of the negative electrode and positive electrode as well as electrolyte solution in the lithium metal secondary battery to form a better interface film.

In an embodiment, the fluorine-containing ether can be selected from a group consisting of 1,1,2,2-Tetrafluoroethyl-2,2,3,3-tetrafluoropropyl ether (TTE), propyl 1,1,2,2-tetrafluoroethyl ether, 1,1,2,2-tetrafluoroethyl-2,2,2-trifluoroethyl ether (HFE), 1,1,1,2,2,3,3,4,4-nonafluoro-4-methoxybutane (PFE-1) and 2-[difluoro (methoxy) methyl]-1,1,1,2,3,3,3-heptafluoropropane (PFE-2). The fluorine-containing ether has a low viscosity, and the use of which as an ingredient in an organic solvent can effectively reduce the viscosity of the non-aqueous electrolyte solution to facilitate impregnation of the negative electrode 100 and the positive electrode 110. In addition, the fluorine-containing ether can also improve the affinity of the electrolyte and the organic solvent to form a better interface film.

In an embodiment, the volume ratio of fluorine-containing cyclic carbonate to fluorine-containing ether is 1:9 to 9:1. In a preferred embodiment, the volume ratio of fluorine-containing cyclic carbonate to fluorine-containing ether is 2:8 to 1:1. In a more preferred embodiment, the volume ratio of fluorine-containing cyclic carbonate to fluorine-containing ether is 3:7.

In an embodiment, the electrolyte in the non-aqueous electrolyte solution includes lithium salt. Lithium salt can be selected from a group consisting of LiPF₆, LTFSI, LFSI, LiBF₄, LiDFOB. The concentration of electrolyte in the non-aqueous electrolyte solution is preferably in a range of 0.8 to 1.2 M. In the embodiment, the concentration of the electrolyte in the non-aqueous electrolyte solution is 1 M.

In a preferred embodiment, the organic solvent in the non-aqueous electrolyte solution includes at least one fluorine-containing cyclic carbonate, at least one fluorine-containing ether and at least one non-fluorinated carbonate. The above non-fluorinated carbonate is, for example, a chain carbonate. For example, the above non-fluorinated carbonate includes ethyl methyl carbonate (EMC), diethyl carbonate (DEC), dimethyl carbonate (DMC) or a combination thereof. Since the lithium salt (such as LiPF₆) has low solubility in the fluorine-containing ether and the interaction between the lithium salt and the organic solvent only composed of the fluorine-containing cyclic carbonate and the fluorine-containing ether is low, the solvation of lithium ion by solvent molecules mentioned above is poor and this generates the phenomenon of the phase instability. In addition, since the organic electrolyte composed of the fluorine-containing cyclic carbonate and the fluorine-containing ether has higher viscosity, the ion mobility of which is relatively low and would affect the electrical conductivity of the ion. Based on this, the non-fluorinated carbonate (such as ethyl methyl carbonate) is further added in the organic electrolyte composed of the fluorine-containing cyclic carbonate and the fluorine-containing ether to further solve the above problems. The ethyl methyl carbonate could be used to improve the interaction between the lithium salt (such as LiPF₆) and the organic solvents including thereof. Moreover, the ethyl methyl carbonate could dissolve in the polar fluorine-containing cyclic carbonate (such as 4-fluoro-1,3-dioxolan-2-one) and the nonpolar fluorine-containing ether (such as 1,1,2,2-tetrafluoroethyl-2,2,3,3-tetrafluoropropyl ether) to be used as “a bridge” between thereof, which could solve the phenomenon of the phase instability. Furthermore, the added ethyl methyl carbonate could lower the viscosity of the organic solvent, so that the ion mobility of the organic electrolyte is improved and the electrical conductivity of the ion is further increased.

In an embodiment, the volume ratio of the at least one fluorine-containing cyclic carbonate to the at least one fluorine-containing ether to the at least one non-fluorinated carbonate is 3:(6˜3):(1˜4). For example, the volume ratio of the at least one fluorine-containing cyclic carbonate to the at least one fluorine-containing ether to the at least one non-fluorinated carbonate could be 3:6:1, 3:5:2, 3:4:3, or 3:3:4. In a preferred embodiment, the volume ratio of the at least one fluorine-containing cyclic carbonate to the at least one fluorine-containing ether to the at least one non-fluorinated carbonate is 3:5:2.

### Examples

The disclosure will be further described below with several examples, but these examples are only for illustrative purposes, not to limit the scope of the disclosure.

In the following examples, the negative electrode material of the lithium metal secondary battery is lithium, the positive electrode material of the lithium metal secondary battery is lithium-nickel-manganese-cobalt oxide, and the non-aqueous electrolyte solution of the lithium metal secondary battery includes an organic solvent in which the volume ratio of FEC to TTE is 3:7 as well as a LiPF₆ salt with concentration of 1M.

FIG. 2 is a curve diagram showing the coulombic efficiency and specific capacity, which are changed along with the number of cycles, of a lithium metal secondary battery according to an embodiment of the disclosure, wherein the current density is 0.2 mA/cm². It can be seen from FIG. 2 that the specific capacity of the lithium metal secondary battery during charging and discharging are decreased in the same manner substantially as the number of cycles of the battery increased. In addition, after the first cycle, the lithium metal secondary battery has an average coulombic efficiency of about 98.94%, showing good performance in both the positive and negative electrodes, and both can form a stable interface film; no dendrites and dead lithium are generated at the negative electrode, and there is no decomposition of electrolyte solution at the positive electrode.

FIG. 3 shows a voltage-to-time curve diagram for electroplating/stripping performance of lithium in a lithium metal secondary battery according to an embodiment of the disclosure.

FIG. 3 shows the plating/stripping performance of lithium in the negative electrode, wherein the electrolyte solution of the lithium metal secondary battery includes an organic solvent in which the volume ratio of FEC to TTE is 3:7 as well as a LiPF₆ salt with concentration of 1M. The current density is 0.6 mA/cm², plating and stripping time is 250 hours, and cut-off voltage is ±0.1V.

After the first few cycles, the voltage is maintained stably at approximately 0.05V in multiple cycles in the 250 hours, which is due to the extremely high coulombic efficiency of the lithium metal secondary battery, that is, the plating/stripping performance of lithium on the negative electrode is good, thus forming a stable interface film without generating any dendrites and dead lithium.

FIG. 4 shows a charge-discharge curve diagram of a lithium metal secondary battery according to an embodiment of the disclosure, wherein the current density is 0.2 mA/cm², the plating time is 8.18 hours, and the stripping voltage is 0.1 V. FIG. 4 shows that the lithium metal secondary battery has undergone one cycle, 20 cycles, 50 cycles, 90 cycles, and 120 cycles of charging and discharging respectively. In spite of the multiple times of cycles, the increase in polarization is not large. That is, the lithium metal secondary battery of the embodiment has a slower electrode aging rate.

FIG. 5 shows an AC impedance diagram of a lithium metal secondary battery according to an embodiment of the disclosure. As can be seen from FIG. 5, the lithium metal secondary battery of this embodiment maintains the impedance at about 13Ω after 5 cycles, and still has a stable impedance even after 40 cycles. That is, lithium has good performance in plating/stripping at the negative electrode, thus forming a stable interface film without generating any dendrites and dead lithium.

FIG. 6 shows an AC impedance diagram of a lithium metal secondary battery of a comparative example. In this comparative example, the non-aqueous electrolyte solution of the lithium metal secondary battery includes ethylene carbonate and diethyl carbonate in a volume ratio of 3:7. It can be seen from FIG. 6 that the impedance of the lithium metal secondary battery of the Comparative Example after multiple cycles is significantly greater than the impedance of the lithium metal secondary battery of the foregoing embodiment of the disclosure. That is, lithium has poor plating/stripping performance in the negative electrode, which is likely to form an unstable interface film and generate dendrites or dead lithium.

### EXPERIMENT EXAMPLE

The following will further illustrate the disclosure through several experimental examples, but these experimental examples are for illustrative purposes only, not to limit the scope of the disclosure.

### Experiment Example 1

In the following examples, various non-aqueous electrolyte solutions are used in lithium metal secondary battery, wherein the negative electrode material of the lithium metal secondary battery is lithium and the positive electrode material is lithium-nickel-manganese-cobalt oxide (LiNi_{1/3}Mn_{1/3}Co_{1/3}O₂), and the non-aqueous electrolyte solution includes LiPF₆ salt with a concentration of 1M.

In Example 1, the non-aqueous electrolyte solution of the lithium metal secondary battery includes an organic solvent in which the volume ratio of FEC to TTE is 3:7.

In Example 2, the non-aqueous electrolyte solution of the lithium metal secondary battery includes an organic solvent in which the volume ratio of FEC to TTE is 1:1.

In Example 3, the non-aqueous electrolyte solution of the lithium metal secondary battery includes an organic solvent in which the volume ratio of FEC to TTE is 4:6.

In Example 4, the non-aqueous electrolyte solution of the lithium metal secondary battery includes an organic solvent in which the volume ratio of FEC to DFEC to TTE is 4.4:0.3:5.3.

In Example 5, the non-aqueous electrolyte solution of the lithium metal secondary battery includes an organic solvent in which the volume ratio of FEC to DFEC to TTE is 3:2:5.

In Example 6, the non-aqueous electrolyte solution of the lithium metal secondary battery includes an organic solvent in which the volume ratio of FEC to DFEC to TTE is 3:1:6.

In Example 7, the non-aqueous electrolyte solution of the lithium metal secondary battery includes an organic solvent in which the volume ratio of FEC to DFEC to TTE is 3.66:0.66:5.66.

In Example 8, the non-aqueous electrolyte solution of the lithium metal secondary battery includes an organic solvent in which the volume ratio of FEC to DFEC to TTE is 3.3:1.4:5.3.

In Comparative Example 1, the non-aqueous electrolyte solution of the lithium metal secondary battery includes an organic solvent in which the volume ratio of ethylene carbonate to diethyl carbonate is 3:7.

In addition, part of the experimental data of Example 1 to Example 8 and the experimental data of Comparative Example 1 are summarized in Table 1 below.

TABLE 1

| | Coulombic | Coulombic | Power retention |
|---|---|---|---|
| | efficiency after 1 | efficiency after 20 | rate after |
| | cycle | cycles | 20 cycles |
| Example 1 | 84.8% | 98.6% | 95.99% |
| Example 2 | 74% | 98% | 83% |
| Example 3 | 86.11% | 98.13% | 80.71% |
| Example 4 | 84.15% | 98.02% | 81% |
| Example 5 | 85.15% | 97.5% | 75.91% |
| Example 6 | 78% | 97.2% | 75.87% |
| Example 7 | 86.89% | 97.6% | 73.77% |
| Example 8 | 86.81% | 97.1% | 69.8% |
| Comparative | 83.02% | 89.7% | 17.45% |
| Example 1 | | | |

FIG. 7 shows a discharge curve diagram of the lithium metal secondary battery including the non-aqueous electrolyte solution in Example 1 to Example 8 of the disclosure after undergoing 20 cycles, wherein all of Example 1 to Example 8 have excellent specific capacity. Further, compared to Example 4 to Example 8 in which the non-aqueous electrolyte solution includes two fluorine-containing cyclic carbonates and one fluorine-containing ether, Example 1 to Example 3 in which the non-aqueous electrolyte solution only includes one fluorine-containing cyclic carbonate and one fluorine-containing ether have a better specific capacity.

FIG. 8 is a curve diagram showing the coulombic efficiency, which is changed along with the number of cycles, of the lithium metal secondary battery including non-aqueous electrolyte solution in Example 1 to Example 8 of the disclosure, wherein the current density is 0.2 mA/cm². It can be seen from FIG. 8 that the coulombic efficiency of the lithium metal secondary battery of Example 1 to Example 8 of the disclosure does not change as the number of cycles of battery increases. In addition, after undergoing the first cycle, the lithium metal secondary battery of Example 1 to Example 8 of the disclosure all have an average coulombic efficiency greater than 97% (20 cycles), showing the plating/stripping performance of lithium in the negative electrode is good, thus forming a stable interface film without generating any dendrites and dead lithium.

FIG. 9 is a curve diagram showing the power retention rate, which is changed along with the number of cycles, of the lithium metal secondary battery including non-aqueous electrolyte solution in Example 1 to Example 8 of the disclosure. It can be seen from FIG. 9 that the lithium metal secondary battery of Example 1 to Example 8 of the disclosure has a power retention rate of at least greater than 69% after 20 cycles. That is, the lithium metal secondary battery of Example 1 to Example 8 has a slower battery aging rate. Further, compared to Example 4 to Example 8 in which the non-aqueous electrolyte solution includes two fluorine-containing cyclic carbonates and one fluorine-containing ether, Example 1 to Example 3 in which the non-aqueous electrolyte solution includes only one fluorine-containing cyclic carbonate and one fluorine-containing ether has a better power retention rate.

In addition, in the lithium metal secondary battery of Comparative Example 1, the average coulombic efficiency (20 cycles) and power retention rate (after 20 cycles) thereof are far inferior to the lithium metal secondary battery of Example 1 to Example 8 of the disclosure, which is because the non-aqueous electrolyte solution included in the lithium metal secondary battery of Comparative Example 1 is unfavorable for the growth of the interfacial film, dendrites and dead lithium are easily formed in the negative electrode, and thus causing the electrolyte solution to be decomposed in the positive electrode, and therefore the lithium metal secondary battery has excessively high resistance and poor service life.

### Experimental Example 2

In the following examples, various non-aqueous electrolyte solutions are used in anode-free lithium metal secondary battery, wherein the negative electrode material of the anode-free lithium metal secondary battery is copper, and the positive electrode material is lithium-nickel-manganese-cobalt oxide (LiNi_{1/3}Mn_{1/3}Co_{1/3}O₂), and the non-aqueous electrolyte solution includes LiPF₆ salt.

In Example 9, the non-aqueous electrolyte solution of the anode-free lithium metal secondary battery includes an organic solvent in which the volume ratio of FEC to TTE is 2:8, and the concentration of LiPF₆ is 1M.

In Example 10, the non-aqueous electrolyte solution of the anode-free lithium metal secondary battery includes an organic solvent in which the volume ratio of FEC to TTE is 3:7, and the concentration of LiPF₆ is 1M.

In Example 11, the non-aqueous electrolyte solution of the anode-free lithium metal secondary battery includes an organic solvent in which the volume ratio of FEC to TTE is 4:6, and the concentration of LiPF₆ is 1M.

In Example 12, the non-aqueous electrolyte solution of the anode-free lithium metal secondary battery includes an organic solvent in which the volume ratio of FEC to TTE is 5:5, and the concentration of LiPF₆ is 1M.

In Example 13, the non-aqueous electrolyte solution of the anode-free lithium metal secondary battery includes an organic solvent in which the volume ratio of FEC to DFEC to TTE is 4.4:0.3:5.3, and the concentration of LiPF₆ is 1M.

In Example 14, the non-aqueous electrolyte solution of the anode-free lithium metal secondary battery includes an organic solvent in which the volume ratio of FEC to DFEC to TTE is 3.6:0.66:5.6, and the concentration of LiPF₆ is 1M.

In Example 15, the non-aqueous electrolyte solution of the anode-free lithium metal secondary battery includes an organic solvent in which the volume ratio of FEC to DFEC to TTE is 3:1:6, and the concentration of LiPF₆ is 1M.

In Example 16, the non-aqueous electrolyte solution of the anode-free lithium metal secondary battery includes an organic solvent in which the volume ratio of FEC to DFEC to TTE is 3.3:1.4:5.3, and the concentration of LiPF₆ is 1M.

In Example 17, the non-aqueous electrolyte solution of the anode-free lithium metal secondary battery includes an organic solvent in which the volume ratio of FEC to DFEC to TTE is 3.3:2:5, and the concentration of LiPF₆ is 1M.

In Comparative Example 2, the non-aqueous electrolyte solution of the anode-free lithium metal secondary battery includes an organic solvent in which the volume ratio of ethylene carbonate to diethyl carbonate is 1:1, and the concentration of LiPF₆ is 1M.

In Comparative Example 3, the non-aqueous electrolyte solution of the anode-free lithium metal secondary battery includes an organic solvent, in which the volume ratio of ethylene carbonate to diethyl carbonate is 1:1, and 5% of FEC, and the concentration of LiPF₆ is 1M.

In Comparative Example 4, the non-aqueous electrolyte solution of the anode-free lithium metal secondary battery includes an organic solvent in which the volume ratio of ethylene carbonate to diethyl carbonate is 1:1, and the concentration of LiPF₆ is 3M.

In Comparative Example 5, the non-aqueous electrolyte solution of the anode-free lithium metal secondary battery includes an organic solvent, in which the volume ratio of ethylene carbonate to diethyl carbonate is 1:1, and 10% of FEC, and the concentration of LiPF₆ is 3M.

In Comparative Example 6, the non-aqueous electrolyte solution of the anode-free lithium metal secondary battery includes an organic solvent, in which the volume ratio of ethylene carbonate to diethyl carbonate is 1:1, and further includes an electrolyte of LiBOB, wherein the concentration of LiPF₆ and LiBOB is 1M, and the volume ratio thereof is 7:3.

In Comparative Example 7, the non-aqueous electrolyte solution of the anode-free lithium metal secondary battery includes an organic solvent in which the volume ratio of ethylene carbonate to diethyl carbonate is 3:7, and the concentration of LiPF₆ is 1M.

In Comparative Example 8, the non-aqueous electrolyte solution of the anode-free lithium metal secondary battery includes an organic solvent, in which the volume ratio of ethylene carbonate to diethyl carbonate is 3:7, and further includes an electrolyte of LiTFSI, wherein the concentration of LiPF₆ and LiTFSI is 2M, and the volume ratio thereof is 1:1.

In Comparative Example 9, the non-aqueous electrolyte solution of the anode-free lithium metal secondary battery includes an organic solvent in which the volume ratio of ethylene carbonate to diethyl carbonate is 1:1, and the concentration of LiPF₆ is 2M.

In Comparative Example 10, the non-aqueous electrolyte solution of the anode-free lithium metal secondary battery includes an organic solvent, in which the volume ratio of ethylene carbonate to diethyl carbonate is 1:1, and 25% of potassium nitrate, and the concentration of LiPF₆ is 1M.

In Comparative Example 11, the non-aqueous electrolyte solution of the anode-free lithium metal secondary battery includes an organic solvent having ethylene carbonate and diethyl carbonate in a volume ratio of 1:1 and is diluted with 50% of FEC, and the concentration of LiPF₆ is 2M.

In Comparative Example 12, the non-aqueous electrolyte solution of the anode-free lithium metal secondary battery includes an organic solvent, in which the volume ratio of ethylene carbonate to diethyl carbonate is 1:1, and 2% of potassium hexafluorophosphate, and the concentration of LiPF₆ is 1M.

In Comparative Example 13, the non-aqueous electrolyte solution of the anode-free lithium metal secondary battery includes an organic solvent, in which the volume ratio of ethylene carbonate to diethyl carbonate is 1:1, 2% of potassium hexafluorophosphate, and 2% of tris (trimethylsilyl) phosphite, and the concentration of LiPF₆ is 2M.

In addition, part of the experimental data of Example 9 to Example 17 and the experimental data of Comparative Example 2 to Comparative Example 13 are summarized in Table 2 below.

TABLE 2

| | Average Coulombic | |
|---|---|---|
| | efficiency when power | Number of cycles when |
| | retention rate is 50% | power retention rate is 50% |
| Example 9 | 96.54% | 43 |
| Example 10 | 98.67% | 65 |
| Example 11 | 98.37% | 67 |
| Example 12 | 98.51% | 68 |
| Example 13 | 98.63% | 53 |
| Example 14 | 98.03% | 48 |
| Example 15 | 97.94% | 40 |
| Example 16 | 97.52% | 39 |
| Example 17 | 96.45% | 36 |
| Comparative | 84.59% | 5 |
| Example 2 | | |
| Comparative | 96.63% | 28 |
| Example 3 | | |
| Comparative | 91.18% | 10 |
| Example 4 | | |
| Comparative | 96.63% | 29 |
| Example 5 | | |
| Comparative | 91.8% | 12 |
| Example 6 | | |
| Comparative | 96.13% | 24 |
| Example 7 | | |
| Comparative | 88.4% | 6 |
| Example 8 | | |
| Comparative | 92.6% | 12 |
| Example 9 | | |
| Comparative | 96.88% | 46 |
| Example 10 | | |
| Comparative | 97.6% | 39 |
| Example 11 | | |
| Comparative | 93.13% | 13 |
| Example 12 | | |
| Comparative | 96.13% | 19 |
| Example 13 | | |

FIG. 10 shows a charge-discharge curve diagram of the anode-free lithium metal secondary battery including the non-aqueous electrolyte solution in Example 3 and Comparative Example 2 of the disclosure after undergoing 3 cycles and 15 cycles respectively. FIG. 11 is a curve diagram showing the specific capacity, which is changed along with the number of cycles, of the anode-free lithium metal secondary battery including non-aqueous electrolyte solution in Example 3 and Comparative Example 2 of the disclosure, wherein the current density is 0.5 mA/cm², and the cycle runs at a voltage of 2.5 to 4.5V. FIG. 12 is a curve diagram showing the coulombic efficiency, which is changed along with the number of cycles, of the anode-free lithium metal secondary battery including non-aqueous electrolyte solution in Example 3 and Comparative Example 2 of the disclosure, wherein the current density is 0.5 mA/cm², and the cycle runs at a voltage of 2.5 to 4.5V.

In FIG. 10 to FIG. 12 and Table 2, the anode-free lithium metal secondary batteries respectively including non-aqueous electrolyte solution of Example 3 and Comparative Example 2 have similar specific capacity at the beginning of cycles. However, after 15 cycles, the specific capacity of the anode-free lithium metal secondary battery of Comparative Example 2 decays rapidly, and the power retention rate thereof is less than 50% after 5 cycles. The poor charge-discharge reversibility and coulombic efficiency of the anode-free lithium metal secondary battery of Comparative Example 2 results from the unstable interface film formed by lithium on the copper negative electrode current collector. In detail, during the electroplating (charging) process, lithium forms an interface film with multiple dendrites and/or mossy structures on the copper negative electrode current collector. During the stripping (discharging) process, the lithium inside the dendrites and/or mossy structures is not completely stripped and becomes dead lithium. As a result, in the next electroplating process, the dendrites and/or mossy structures will continue to grow and eventually pierce the separator film to cause a short circuit. Relatively, the anode-free lithium metal secondary battery of Example 3 still has a power retention rate greater than 50% after undergoing about 65 cycles, and has an average coulombic efficiency of about 98.67% at a current density of 0.5 mA/cm², showing that lithium has good performance in plating/stripping at the negative electrode and forms a stable interface film without generating any dendrites and dead lithium, and inhibits the decomposition of the electrolyte solution at the positive electrode.

### Experimental Example 3

In the following examples, the non-aqueous electrolyte solution of Example 3 and Comparative Example 2 are used in the lithium metal secondary battery of Example A, the lithium ion secondary battery of Example B, and the lithium ion secondary battery of Example C.

The negative electrode material of the lithium metal secondary battery of Example A is lithium, the positive electrode material thereof is high-voltage lithium-nickel-manganese-cobalt oxide (LiNi_{1/3}Mn_{1/3} Co_{1/3} O₂), and the electrolyte solution includes a LiPF₆ salt with a concentration of 1M.

The negative electrode material of the lithium ion secondary battery of Example B is mesocarbon microbeads (MCMB), the positive electrode material thereof is high-voltage lithium-nickel-manganese-cobalt oxide (LiNi_{1/3}Mn_{1/3}Co_{1/3}O₂), and the electrolyte solution includes a LiPF₆ salt with a concentration of 1M.

The negative electrode material of the lithium ion secondary battery of Example C is mesocarbon microbeads (MCMB), the positive electrode material thereof is high-voltage lithium-nickel-manganese oxide (LiNi_{0.5}Mn_{1.5}O₄), and the electrolyte solution includes a LiPF₆ salt with a concentration of 1M.

FIG. 13A shows a charge-discharge curve diagram of the lithium metal secondary battery in Example A including the non-aqueous electrolyte solution in Example 3 and Comparative Example 2 of the disclosure after undergoing 1 cycle and 100 cycles respectively. FIG. 13B is a curve diagram showing the specific capacity, which is changed along with the number of cycles, of the lithium metal secondary battery in Example A including non-aqueous electrolyte solution in Example 3 and Comparative Example 2 of the disclosure, wherein the current density is 0.5 mA/cm², and the cycle runs at a voltage of 2.5 to 4.5V.

In FIG. 13A and FIG. 13B, the lithium metal secondary battery of Example A including the non-aqueous electrolyte solution of Example 3 still has about 91.80% of initial discharge capacity and 99.83% of coulombic efficiency after 100 cycles, which shows that lithium has good performance in plating/stripping at the negative electrode, thus forming a stable interface film without generating any dendrites and dead lithium, and can inhibit the decomposition of the electrolyte solution at the positive electrode. In contrast, after about 70 cycles, the lithium metal secondary battery of Example A including the non-aqueous electrolyte solution of Comparative Example 2 obviously failed.

FIG. 14A shows a charge-discharge curve diagram of the lithium ion secondary battery in Example B including the non-aqueous electrolyte solution in Example 3 and Comparative Example 2 of the disclosure after undergoing 1 cycle and 150 cycles respectively. FIG. 14B is a curve diagram showing the specific capacity, which is changed along with the number of cycles, of the lithium ion secondary battery in Example B including non-aqueous electrolyte solution in Example 3 and Comparative Example 2 of the disclosure, wherein the current density is 0.5 mA/cm², and the cycle runs at a voltage of 2.5 to 4.5V.

In FIG. 14A and FIG. 14B, the lithium ion secondary battery of Example B including the non-aqueous electrolyte solution of Example 3 still has about 88.2% of initial discharge capacity and coulombic efficiency greater than 99.5% after 150 cycles, which shows that lithium has good performance in plating/stripping at the negative electrode, thus forming a stable interface film without generating any dendrites and dead lithium, and can inhibit the decomposition of the electrolyte solution at the positive electrode. In contrast, the specific capacity of the lithium ion secondary battery of Example B including the non-aqueous electrolyte solution of Comparative Example 2 decayed rapidly after multiple cycles, and the power retention rate thereof after 150 cycles is less than 70%.

FIG. 15A shows a charge-discharge curve diagram of the lithium ion secondary battery in Example C including the non-aqueous electrolyte solution in Example 3 and Comparative Example 2 of the disclosure after undergoing 1 cycle and 150 cycles respectively.

FIG. 15B is a curve diagram showing the specific capacity, which is changed along with the number of cycles, of the lithium ion secondary battery in Example C including non-aqueous electrolyte solution in Example 3 and Comparative Example 2 of the disclosure, wherein the current density is 0.5 mA/cm², and the cycle runs at a voltage of 3.2 to 5 V.

In FIG. 15A and FIG. 15B, the lithium ion secondary battery of Example C including the non-aqueous electrolyte solution of Example 3 still has about 65.09% of initial discharge capacity and 99.4% of coulombic efficiency after 150 cycles, which shows that lithium has good performance in plating/stripping at the negative electrode, thus forming a stable interface film without generating any dendrites and dead lithium, and can inhibit the decomposition of the electrolyte solution at the positive electrode. In contrast, the specific capacity of the lithium ion secondary battery of Example C including the non-aqueous electrolyte solution of Comparative Example 2 decayed rapidly after multiple cycles, and the power retention rate thereof after 150 cycles is only 29.15%.

### Experimental Example 4

In the following examples, various non-aqueous electrolyte solutions are used in anode-free lithium metal secondary battery, wherein the negative electrode material of the anode-free lithium metal secondary battery is copper, and the positive electrode material is lithium-nickel-manganese-cobalt oxide (LiNi_{1/3}Mn_{1/3}Co_{1/3}O₂), and the non-aqueous electrolyte solution includes LiPF₆ salt.

In Example 18, the non-aqueous electrolyte solution of the anode-free lithium metal secondary battery includes an organic solvent in which the volume ratio of FEC to TTE to EMC is 3:5:2.

In Comparative Example 14, the non-aqueous electrolyte solution of the anode-free lithium metal secondary battery includes an organic solvent in which the volume ratio of FEC to TTE is 3:7.

In Comparative Example 15, the non-aqueous electrolyte solution of the anode-free lithium metal secondary battery includes an organic solvent in which the volume ratio of EC to DEC is 1:1.

In addition, part of the experimental data of Example 18 and the experimental data of Comparative Examples 14 and 15 are summarized in Table 3 below.

TABLE 3

| | | | Power retention |
|---|---|---|---|
| | Coulombic | Average coulombic | rate after |
| | efficiency after 1 | efficiency after 30 | 30 cycles/ |
| | cycle | cycles/80 cycles | 80 cycles |
| Example 18 | 84.5% | 98.0%/98.3% | 77.2%/40.0% |
| Comparative | 87.0% | 97.5%/97.3% | 57.6%/16.0% |
| Example 14 | | | |
| Comparative | 86.0% | 91.2%/— | 9.2%/— |
| Example 15 | | | |

FIG. 16 shows a charge-discharge curve diagram of the anode-free lithium metal secondary battery including the non-aqueous electrolyte solution in Example 18 of the disclosure after undergoing 1 cycle, 5 cycles, 10 cycles and 15 cycles respectively. FIG. 17 shows a charge-discharge curve diagram of the anode-free lithium metal secondary battery including the non-aqueous electrolyte solution in Comparative Example 14 of the disclosure after undergoing 1 cycle, 5 cycles, 10 cycles and 15 cycles respectively. FIG. 18 shows a charge-discharge curve diagram of the anode-free lithium metal secondary battery including the non-aqueous electrolyte solution in Comparative Example 15 of the disclosure after undergoing 1 cycle, 5 cycles, 10 cycles and 15 cycles respectively. FIG. 19 is a curve diagram showing the specific capacity, which is changed along with the number of cycles, of the anode-free lithium metal secondary battery including non-aqueous electrolyte solution in Example 18, Comparative Example 14 and Comparative Example 15 of the disclosure, wherein the charge density is 0.2 mA/cm², discharge density is 0.5 mA/cm² and the cycle runs at a voltage of 2.5 to 4.5V. FIG. 20 is a curve diagram showing the power retention rate and the coulombic efficiency, which are changed along with the number of cycles, of the anode-free lithium metal secondary battery including non-aqueous electrolyte solution in Example 18, Comparative Example 14 and Comparative Example 15 of the disclosure, wherein the charge density is 0.2 mA/cm², discharge density is 0.5 mA/cm² and the cycle runs at a voltage of 2.5 to 4.5V.

In FIG. 16 to FIG. 20 and Table 3, the anode-free lithium metal secondary batteries respectively including non-aqueous electrolyte solution of Example 18 and Comparative Examples 14 and 15 have similar specific capacity at the beginning of cycles. However, after 15 cycles, the specific capacity of the anode-free lithium metal secondary battery of Comparative Example 15 decays rapidly, and the power retention rate thereof is less than 10% after 30 cycles. In addition, after 15 cycles, the specific capacity of the anode-free lithium metal secondary battery of Comparative Example 14 also slightly decays, and the power retention rate thereof is only 57.6% after 30 cycles. The poor charge-discharge reversibility and coulombic efficiency of the anode-free lithium metal secondary battery of Comparative Example 15 results from the unstable interface film formed by lithium on the copper negative electrode current collector. In detail, during the electroplating (charging) process, lithium forms an interface film with multiple dendrites and/or mossy structures on the copper negative electrode current collector. During the stripping (discharging) process, the lithium inside the dendrites and/or mossy structures is not completely stripped and becomes dead lithium. As a result, in the next electroplating process, the dendrites and/or mossy structures will continue to grow and eventually pierce the separator film to cause a short circuit. Although the anode-free lithium metal secondary batteries of Comparative Example 14 has no above disadvantages, but it exhibits the limited coulombic efficiency and the limited power retention rate due to the poor solvation energy and high viscosity of the non-aqueous electrolyte solution. Relatively, the anode-free lithium metal secondary battery of Example 18 still has a power retention rate of 40.0% after undergoing 80 cycles, and has an average coulombic efficiency of about 98.3%, showing that lithium has good performance in plating/stripping at the negative electrode and forms a stable interface film without generating any dendrites and dead lithium, and inhibits the decomposition of the electrolyte solution at the positive electrode. Furthermore, since the organic solvent of the non-aqueous electrolyte solution used in Example 18 further includes non-fluorinated carbonate, the anode-free lithium metal secondary battery of Example 18 has the greater solvation energy and low viscosity of the non-aqueous electrolyte solution compared to the anode-free lithium metal secondary batteries of Comparative Example 14, thereby having the greater coulombic efficiency and the greater power retention rate.

In summary, the disclosure provides a non-aqueous electrolyte solution that can be used for high-voltage lithium metal secondary battery and lithium ion secondary battery including high-voltage positive electrode material, and the components thereof include fluorine-containing cyclic carbonate and fluorine-containing ether, and the volume ratio thereof is between 2:8 to 1:1. Furthermore, in preferred embodiment of the disclosure, the content of the non-aqueous electrolyte solution further includes non-fluorinated carbonate, and the volume ratio of the fluorine-containing cyclic carbonate to the fluorine-containing ether to the non-fluorinated carbonate is 3:(6˜3):(1˜4). Based on the above, the non-aqueous electrolyte solution of the disclosure makes it possible for the negative electrode of the high-voltage lithium metal secondary battery and the lithium ion secondary battery including high-voltage positive electrode material to form a stable interface film during charging and discharging without generating any dendrites and dead lithium, and such stable interface film does not disintegrate due to the increase in the number of cycles. Furthermore, the non-aqueous electrolyte solution provided by the disclosure does not decompose on the surface of the positive electrode by oxidation, which makes the high-voltage lithium metal secondary battery and the lithium ion secondary battery including high-voltage positive electrode material of the disclosure still have a relatively high coulombic efficiency and power retention rate after multiple cycles, and thus having a high cycle life.

Although the present disclosure has been disclosed in the above embodiments, it is not intended to limit the present disclosure, and those skilled in the art can make some modifications and refinements without departing from the spirit and scope of the disclosure. Therefore, the scope of the present disclosure is subject to the definition of the scope of the appended claims.

What is claimed is:

1. A non-aqueous electrolyte solution, comprising:
at least one fluorine-containing cyclic carbonate; and
at least one fluorine-containing ether,
wherein the volume ratio of the at least one fluorine-containing cyclic carbonate to the at least one fluorine-containing ether is 1:9 to 9:1.

2. The non-aqueous electrolyte solution according to claim 1, wherein the at least one fluorine-containing cyclic carbonate comprises 4-fluoro-1,3-dioxolan-2-one (FEC), 4,5-difluoro-1,3-dioxolan-2-one (DFEC), 3,3,3-fluoroethylmethyl carbonate (FEMC), ethyl difluoroacetate (DFEAc), di-2,2,2-trifluoroethyl carbonate (TFEC) or a combination thereof.

3. The non-aqueous electrolyte solution according to claim 1, wherein the at least one fluorine-containing ether comprises 1,1,2,2-Tetrafluoroethyl-2,2,3,3-tetrafluoropropyl ether (TTE), propyl 1,1,2,2-tetrafluoroethyl ether, 1,1,2,2-tetrafluoroethyl-2,2,2-trifluoroethyl ether (HFE), 1,1,1,2,2,3,3,4,4-nonafluoro-4-methoxybutane (PFE-1), 2-[difluoro (methoxy) methyl]-1,1,1,2,3,3,3-heptafluoropropane (PFE-2) or a combination thereof.

4. The non-aqueous electrolyte solution according to claim 1, wherein the volume ratio of the at least one fluorine-containing cyclic carbonate to the at least one fluorine-containing ether is 2:8 to 1:1.

5. The non-aqueous electrolyte solution according to claim 1, wherein the volume ratio of the at least one fluorine-containing cyclic carbonate to the at least one fluorine-containing ether is 3:7.

6. The non-aqueous electrolyte solution according to claim 1, wherein the non-aqueous electrolyte solution comprises one fluorine-containing cyclic carbonate and one fluorine-containing ether.

7. The non-aqueous electrolyte solution according to claim 1, further comprising lithium salt.

8. A lithium metal secondary battery, comprising:
a negative electrode, comprising a metal material;
a positive electrode; and
the non-aqueous electrolyte solution as claimed in claim 1.

9. A lithium ion secondary battery, comprising:
a negative electrode, comprising a non-metal material;
a positive electrode; and
the non-aqueous electrolyte solution as claimed in claim 1.

10. A non-aqueous electrolyte solution, comprising:
at least one fluorine-containing cyclic carbonate;
at least one fluorine-containing ether; and
at least one non-fluorinated carbonate,
wherein the volume ratio of the at least one fluorine-containing cyclic carbonate to the at least one fluorine-containing ether to the at least one non-fluorinated carbonate is 3:(6˜3):(1˜4).

11. The non-aqueous electrolyte solution according to claim 10, wherein the at least one non-fluorinated carbonate comprises ethyl methyl carbonate (EMC), diethyl carbonate (DEC), dimethyl carbonate (DMC) or a combination thereof.

12. The non-aqueous electrolyte solution according to claim 10, wherein the volume ratio of the at least one fluorine-containing cyclic carbonate to the at least one fluorine-containing ether to the at least one non-fluorinated carbonate is 3:5:2.

13. A lithium metal secondary battery, comprising:
a negative electrode, comprising a negative electrode current collector;
a positive electrode; and
the non-aqueous electrolyte solution as claimed in claim 10.
